(19) United States
(12) Patent Application Publication
(10) Pub. No.: US 2026/0333223 A1
(43) Pub. Date: Oct. 22, 2026

(54) Upper Layer Aspects of UL Wakeup Signal for Cell Wakeup in IDLE/INACTIVE State

(71) Applicant: Apple Inc., Cupertino, CA (US)

(72) Inventors: Peng CHENG, Beijing (CN); Fangli XU, Beijing (CN); Haijing HU, Los Gatos, CA (US); Sigen YE, San Diego, CA (US)

(21) Appl. No.: 19/116,650

(22) PCT Filed: Sep. 29, 2022
(86) PCT No.: PCT/CN2022/122869

§ 371 Date: Mar. 28, 2025

(51) Int. Cl. H04W 52/02; H04W 74/0833; H04W 76/28

(52) U.S. Cl. CPC H04W 52/0235; H04W 74/0833; H04W 76/28

(57) ABSTRACT

A user equipment (UE) configured to receive a configuration from a network cell for an uplink (UL) wakeup signal (WUS) resource, determine to transmit a UL WUS when a condition is triggered, the condition comprising either one of UL data arrival or a triggering of a random access (RACH) procedure when the network cell is in a sleep state or is anticipated to enter the sleep state in an upcoming duration, select a sequence for transmitting the UL WUS, the sequence comprising a physical RACH (PRACH) preamble reserved for UL WUS or a sequence introduced for UL WUS, transmit the UL WUS and monitor for signaling indicating whether the network cell wakes up or enters a different sleep state.

### TECHNICAL FIELD

The present disclosure generally relates to wireless communication, and in particular, to upper layer aspects of UL wakeup signal for cell wakeup in idle/inactive state.

### BACKGROUND INFORMATION

A user equipment (UE) may establish a connection to at least one of a plurality of different networks or types of networks. For some types of network communications, the VE may be configured with a discontinuous reception (DRX) cycle or a discontinuous transmission (DTX) cycle to conserve power. The DRX/DTX cycle for the UE utilizes an active mode (ON duration) of data exchange processing and a sleep mode (OFF duration) of inactivity. A network cell (e.g., base station) can configure the DRX/DTX cycle for the UE and exchange communications with the UE, e.g., transmit downlink (DL) data/channels or reference signals and receive uplink (UL) transmissions, in dependence on the parameters of the DRX/DTX cycle(s) configured for the UE.

In 5G New Radio (NR), techniques can be implemented at the network cell (e.g., base station or gNB) to conserve power, including a cell DRX/DTX cycle where the gNB is configured with an active mode (ON duration) and a sleep mode (OFF duration). A UL wakeup signal (WUS) refers to a layer 1 (L1) signaling transmitted by the UE to notify/request the gNB to wake up from a sleep mode or state. However, the radio resource control (RRC) signaling/configuration and medium access control (MAC) behavior for the UL WUS is not well defined.

### SUMMARY

Some exemplary embodiments are related to a method performed by a user equipment (UE). The method includes receiving a configuration from a network cell for an uplink (UL) wakeup signal (WUS) resource, determining to transmit a UL WUS when a condition is triggered, the condition comprising either one of UL data arrival or a triggering of a random access (RACH) procedure when the network cell is in a sleep state or is anticipated to enter the sleep state in an upcoming duration, selecting a sequence for transmitting the UL WUS, the sequence comprising a physical RACH (PRACH) preamble reserved for UL WUS or a sequence introduced for UL WUS, transmitting the UL WUS and monitoring for signaling indicating whether the network cell wakes up or enters a different sleep state.

Other exemplary embodiments are related to a method performed by a base station. The method includes transmitting a configuration to a user equipment (UE) for an uplink (UL) wakeup signal (WUS) resource, receiving a UL WUS from the UE, the UL WUS being transmitted using a sequence comprising a physical RACH (PRACH) preamble reserved for UL WUS or a sequence introduced for UL WUS, the UL WUS indicating either one of UL data arrival or a triggering of a random access (RACH) procedure for the UE and determining whether to wake up or enter a different sleep state in an upcoming duration based in part on the received UL WUS.

### BRIEF DESCRIPTION OF THE DRAWINGS

FIG. 1 shows a timing diagram for a DTX/DRX cycle for a cell according to one example.

FIG. 2a shows a diagram for a periodic UL WUS resource configured in the ON duration of a cell DRX/DTX cycle according to various exemplary embodiments.

FIG. 2b shows a diagram for a periodic UL WUS resource configured in the OFF duration of a cell DRX/DTX cycle according to various exemplary embodiments.

FIG. 2c shows a diagram for an aperiodic UL WUS resource configured in the ON duration of a cell DRX/DTX cycle according to various exemplary embodiments.

FIG. 2d shows a diagram for a periodic UL WUS resource configured for a cell sleep state according to various exemplary embodiments.

FIG. 3 shows an exemplary method for configuring a UL wakeup signal (WUS) resource and transmitting a UL WUS according to various exemplary embodiments.

FIG. 4 shows an exemplary network arrangement according to various exemplary embodiments.

FIG. 5 shows an exemplary base station according to various exemplary embodiments.

FIG. 6 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for configuring, triggering and transmitting the UL wakeup signal (WUS) for a UE in the RRC IDLE or INACTIVE state. In particular, medium access layer (MAC) operations are described for the IDLE/INACTIVE UE. In one aspect, UE and network/gNB operations are described for using a system information block (SIB) to configure the resource for the UE to transmit the UL WUS. In another aspect, UE operations are described for triggering the transmission of the UL WUS at the UE. In still another aspect, medium access control (MAC) operations are described for an idle/inactive UE to send the UL WUS. In still another aspect, gNB operations are described upon reception of the UL WUS.

The exemplary embodiments are described with regard to a VE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing DRX/DTX cycles similar to those described herein. Therefore, the 5G NR network as described herein may represent any type of network implementing similar DRX/DTX functionalities as the 5G NR network.

A DRX cycle can be configured for a VE according to existing methodologies to conserve UE power. The DRX cycle utilizes an active mode of data exchange processing and a sleep mode of inactivity. The UE may use the active mode of processing at defined intervals to perform scheduled operations such as performing measurements related to the network conditions, transmitting (e.g., requests, measurement reports, uplink data etc.), and receiving (e.g., control channel information, reference signals, synchronization signals, downlink data, etc.). The time period that the VE may be scheduled to receive may be referred to as the ON duration for the DRX cycle, or a DRX active time. The ON duration for a DRX cycle relates to a duration during which the UE may perform operations that enable the UE to receive data that may be transmitted to the UE such as but not limited to, control channel information, an uplink grant, a downlink grant, reference signals, synchronization signals, payload data etc.

During the DRX cycle, when an ON duration is not scheduled, the UE may have an opportunity to utilize the sleep mode of inactivity and conserve power. This period may be referred to as a DRX inactive time, However, reference to a DRX cycle is for illustrative purposes, and different networks may refer to similar concepts by a different name. The DRX cycle may have a predetermined duration N such as 100 milliseconds (ms), 50 ms, 40 ms, 20 ms, etc. For example, at a time 0, there may be a ON duration during which the active mode of processing is used. Subsequently, upon the conclusion of the ON duration, the VE has an opportunity to utilize the sleep mode of inactivity. Then at a time N, there may be another ON duration. Subsequently, the sleep mode is used until a time 2N. This process continues for the duration of the DRX cycle. Reference to the sleep mode of inactivity does not necessarily mean putting the processor, the transmitter, and the receiver of the UE to sleep, in hibernation, or in deactivation. For example, the processor (e.g., baseband and/or application) may continue to execute other applications or processes. The sleep mode relates to conserving power by discontinuing a continuous processing functionality relating to operations that enable the UE to receive data that may be transmitted to the UE and transmit data to the network. Further, reference to the DRX cycle being configured in ms units is merely for illustrative purposes, the exemplary aspects may utilize a DRX cycle that is based on subframes or any other suitable unit of time.

In Rel-18, techniques can be implemented on both the gNB and user equipment (VE) side to improve network energy consumption, e.g., base station transmission and reception power. These techniques may include more efficient dynamic and/or semi-static operations and finer granularity adaptation of transmissions and/or receptions and relate to the time, frequency, spatial, and/or power domains, with potential support/feedback from the UE, and potential UE assistance information. The techniques may further include information exchange/coordination over network interfaces. Additional/other techniques are not precluded. Idle/empty and low/medium load scenarios can be considered (the exact definition of such loads has not yet been defined), and different loads among carriers and neighbor cells are allowed.

In some examples, the power saving techniques can include gNB (cell) discontinuous transmission (DTX) and/or discontinuous reception (DRX) (or ON-OFF pattern) and uplink (UL) wakeup signal (WUS). Similar to the UE DRX cycle described above, a cell DTX/DRX can utilize an ON duration wherein the gNB can transmit/receive signals/channels and an OFF duration wherein the gNB can disable some types of signal Rx/Tx processing and conserve power. Cell DTX/DRX can be applied to the UE in all RRC states (IDLE, INACTIVE, or CONNECTED) and covers both transmit (Tx) and receive (Rx) of the gNB. The signaling design for implementing cell DTX/DRX and UL WUS should consider the RRC state of the UE.

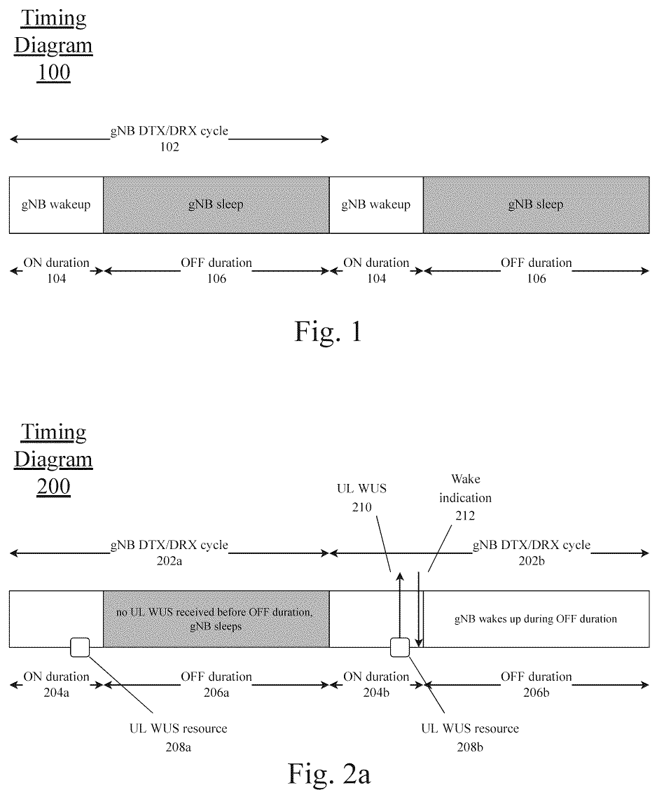

FIG. 1 shows a timing diagram 100 for a DTX/DRX cycle 102 for a cell, e.g., a gNB, according to one example. Each cell DTX/DRX cycle 102 comprises an ON duration 104, during which the power amplifier (PA) and radiofrequency (RF) front end of the gNB are powered on, and an OFF duration 106 when the PA and RF are turned off and the gNB can conserve power. The duration of the cell DTX/DRX cycle 102, and the length of the ON duration 104 relative to the OFF duration 106, can vary.

During the DRX/DTX OFF duration, different gNB sleep modes can be configured for the UE depending on, for example, the power consumption requirements and/or capabilities of different gNBs (e.g., the serving gNB and potentially neighboring gNBs). The sleep modes can correspond to varying levels of power consumption imposed by the Tx/Rx of various types of signals/channels. It is noted that the gNB can configure different sleep modes for different groups of UEs based on various considerations including, e.g., the number of UEs in the cell and the requirements of the various UEs,

An idle/inactive UE can notify a gNB to wake up in some upcoming duration via a UL WUS. When cell DRX/DTX is configured, the UE may have UL traffic/signaling to transmit in an upcoming duration that coincides with an upcoming ON duration or OFF duration of the cell DRX/DTX cycle. The UL WUS can be sent in the cell DRX/DTX ON duration to indicate the UE has UL traffic/signaling to transmit in an upcoming cell DRX/DTX OFF duration, or the UL WUS signal can be sent in the DRX/DTX OFF duration to indicate the UE has UL traffic/signaling to transmit in an upcoming cell DRX/DTX ON duration. When cell DRX/DTX is not configured, and a camping gNB is in another type of sleep mode/state, the UL WUS can be sent to indicate the UE has UL traffic/signaling and trigger RACH.

According to various exemplary embodiments described herein, operations are described for configuring, triggering and transmitting the UL wakeup signal (WUS) for a UE in the RRC IDLE or INACTIVE state. In particular, medium access layer (MAC) operations are described for the IDLE/INACTIVE UE. In one aspect, UE and network/gNB operations are described for using a system information block (SIB) to configure the resource for the UE to transmit the UL WUS. In another aspect, UE operations are described for triggering the transmission of the UL WUS at the UE. In still another aspect, medium access control (MAC) operations are described for an idle/inactive UE to send the UL WUS. In still another aspect, gNB operations are described upon reception of the UL WUS.

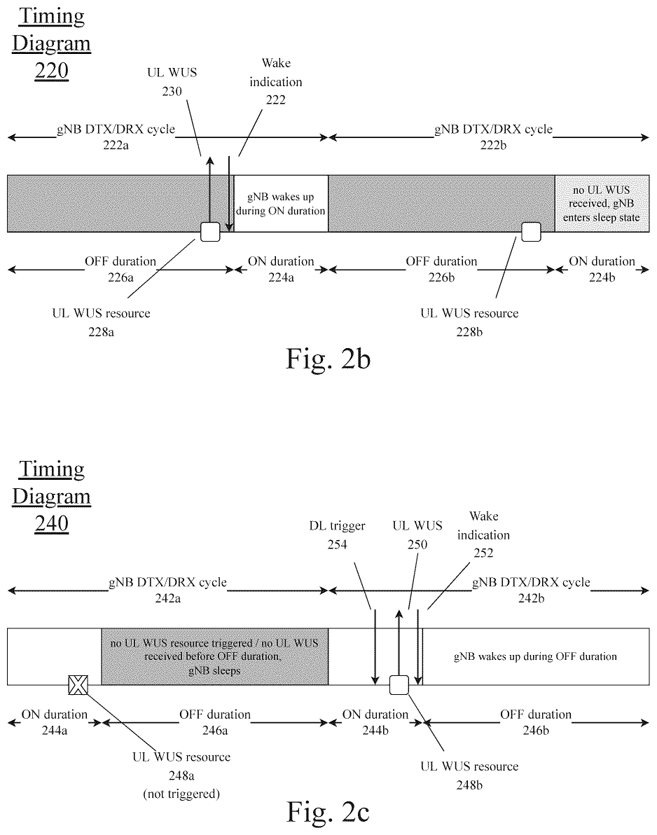

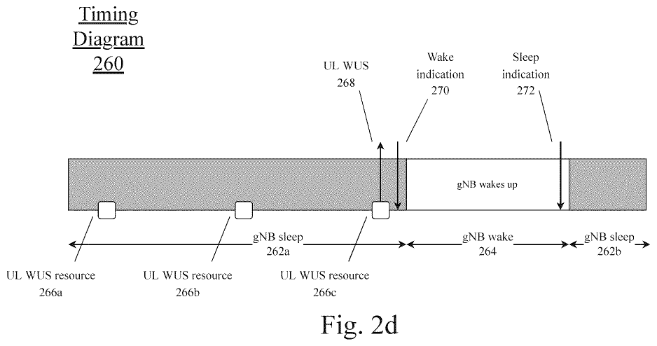

According to one aspect of these exemplary embodiments, the cell-specific UL WUS resource(s) can be configured in SIB. If cell DRX/DTX is configured, the SIB can configure a starting slot for the UL WUS resource (e.g., a slot offset) defined relative to an upcoming cell DRX/DTX ON duration or OFF duration. In some embodiments, the WUS resource can be periodic and the SIB configuration can include a periodicity and the starting slot (slot offset). In one embodiment, the WUS resource can be in the ON duration and configured relative to the starting time of the OFF duration, as shown in FIG. 2a.

In another embodiment, the WUS resource can be in the OFF duration and configured relative to the starting time of the ON duration, as shown in FIG. 2b. In another embodiment, when the WUS resource is configured in the cell ON duration, the WUS resource can be aperiodic and can be triggered by the gNB during the ON duration, as shown in FIG. 2c. If cell DRX/DTX is not configured, the SIB can configure a periodic UL WUS resource including a periodicity and a slot offset, as shown in FIG. 2d.

When cell DRX/DTX is configured, the UL WUS can be sent in either the cell DRX/DTX ON duration or in the cell DRX/DTX OFF duration. In either of these cases, the UL WUS resource can be configured in SIB. The SIB can carry a parameter indicating a value ‘x’ for the slot offset relative to a starting time of the cell DRX/DTX ON duration.

FIG. 2a shows a diagram 200 for a periodic UL WUS resource 208 configured in the ON duration 204 of a cell DRX/DTX cycle 202 according to various exemplary embodiments. The diagram 200 includes two cell/gNB DRX/DTX cycles 202, e.g., cycle 202a followed by cycle 202b. The periodic UL WUS resource 208 is configured to start ‘x’ slots before the start of the OFF duration 206 of the cell DRX/DTX cycle 202. Thus, a first UL WUS resource 208a is configured in the first ON duration 204a and a second UL WUS resource 208b is configured in the second ON duration 204b.

In this example, in the first cell DRX/DTX cycle 202a, the UL WUS is not transmitted in the first UL WUS resource 208a. Thus, the gNB enters a sleep state during the first OFF duration 206a and the UE does not expect to be scheduled during the first OFF duration.

In the second cell DRX/DTX cycle 202b, the UE transmits a UL WUS 210 during the second UL WUS resource 208b. The gNB receiving the UL WUS 210 can determine based on gNB implementation whether to wake up. If the gNB decides to wake up, the UE can receive a confirmation from the gNB that the gNB will wake up, e.g., a wake indication 212. The gNB wakes up during the OFF duration 206b and can schedule the UE for the UL transmission.

FIG. 2b shows a diagram 220 for a periodic UL WUS resource 228 configured in the OFF duration 226 of a cell DRX/DTX cycle 222 according to various exemplary embodiments. The diagram 220 includes two cell/gNB DRX/DTX cycles 222, e.g., cycle 222a followed by cycle 222b, which, in this example, begin with the OFF duration 226 followed by the ON duration 224. The periodic UL WUS resource 228 is configured to start ‘x’ slots before the start of the ON duration 224 of the cell DRX/DTX cycle 222. Thus, a first UL WUS resource 228a is configured in the first OFF duration 226a and a second UL WUS resource 228b is configured in the second OFF duration 226b.

In this example, in the first cell DRX/DTX cycle 222a, the UL WUS 230 is transmitted in the first UL WUS resource 228a. Thus, upon reception of the UL WUS 230, the gNB can transmit and the UE can receive a confirmation that the gNB will wake up, e.g., a wake indication 232. The gNB wakes up during the ON duration 224a and can schedule the UE for the UL transmission.

In the second cell DRX/DTX cycle 222b, the UE does not transmit a UL WUS 230 during the second UL WUS resource 228b. The gNB can enter a sleep state during the second ON duration 224b and the UE does not expect to be scheduled during the second ON duration 224b.

In various embodiments the gNB can enter various types of sleep state based on gNB implementation. The sleep state selected by the gNB can depend on, e.g., a total number of UEs in the cell, a number of UEs sending the UL WUS, and other considerations. In some embodiments, the gNB DRX/DTX cycle can be associated with different sleep states for different groups of UEs. It should be understood that the cell can determine to wake up during the OFF duration, in whole or in part, and can determine to sleep during the ON duration, in whole or in part, in various loading scenarios encountered by the cell. Typically (though not in every scenario), the gNB will perform more scheduling operations in the ON duration than in the OFF duration of the cell DRX/DTX cycle, in accordance with the basic design of the cell DRX/DTX cycle. However, different gNBs may use different implementations, and the gNB determination of when to wake up and when to sleep, and the varying power/sleep states that the gNB can enter during the ON duration and the OFF duration, are outside the scope of the present disclosure. Further, it should be understood that the UL WUS is used to request the gNB to enter a state, in the upcoming OFF or ON duration, allowing increased UL transmissions/signaling relative to the state into which the gNB would otherwise enter. For example, for some upcoming ON duration, the gNB may otherwise decide (if the UL WUS is not received) to enter a light sleep state or some other state that may not permit the UE to transmit its UL data/signaling, despite the duration being an ON duration. The UL WUS can be transmitted during the preceding OFF duration to ensure/request that the gNB enter an activity state during the ON duration that allows the UE to transmit its pending signals/channels.

In another exemplary embodiment, when the UL WUS resource is configured in the cell DRX/DTX ON duration, the resource can be aperiodic. The gNB can configure the UE with the aperiodic UL WUS resource in the ON duration of the cell DRX/DTX cycle. The UL WUS resource can be triggered in the same ON duration via group common (GC) signaling.

The starting slot for the aperiodic UL WUS resource can be defined relative to the start of the OFF duration of the cell DRX/DTX cycle, similar to above. The aperiodic UL WUS resource is not used/available until it is triggered by the gNB. The trigger can comprise a group common DCI (GC-DCI), e.g., a paging short message or a paging early indication (PEI) DCI 2_7. The aperiodic UL WUS resource may be configured only for the ON duration of the cell DRX/DTX cycle, e.g., when the UE is monitoring for paging messages and/or PEI. When the aperiodic UL WUS resource is triggered, the UE can use it to send the UL WUS, if desired, or skip the opportunity to transmit the UL WUS,

FIG. 2c shows a diagram 240 for an aperiodic UL WUS resource 248 configured in the ON duration 244 of a cell DRX/DTX cycle 242 according to various exemplary embodiments. The diagram 240 includes two cell/gNB DRX/DTX cycles 242, e.g., cycle 242a followed by cycle 242b, similar to the diagram 200 of FIG. 2a. The aperiodic UL WUS resource 248 is configured to start ‘x’ slots before the start of the OFF duration 246 of the cell DRX/DTX cycle 242, when triggered.

In this example, in the first cell DRX/DTX cycle 242a, the DL trigger is not received by the UE. Thus, the UL WUS resource (e.g., UL WUS resource 248a) is not available in the first ON duration 244a. The gNB can enter a sleep state during the first OFF duration 246a and the UE does not expect to be scheduled during the first OFF duration 246a.

In the second cell DRX/DTX cycle 242b, a DL trigger 254 is received by the UE during the second ON duration 244b. With the aperiodic WUS resource available, the UE transmits a UL WUS 250 during the UL WUS resource 248b. The gNB receiving the UL WUS 250 can determine based on gNB implementation whether to wake up. If the gNB decides to wake up, the UE can receive a confirmation from the gNB that the gNB will wake up, e.g., a wake indication 252. The gNB wakes up during the OFF duration 246b and can schedule the UE for the UL transmission.

When cell DRX/DTX is not configured, the SIB can configure a periodic UL WUS resource including a periodicity and a slot offset. In some embodiments, the UL WUS can be sent when the gNB is in an inactive state or a sleep state that does not allow certain UL transmissions/signaling. In other embodiments, the gNB can be in a sleep state that allows some UL transmission/signaling, but insufficient resources to permit the UE to effectively transmit. In either scenario, the UL WUS can request the gNB to enter a state allowing increased UL transmissions/signaling relative to its current state.

FIG. 2d shows a diagram 260 for a periodic UL WUS resource 266 configured for a cell sleep state according to various exemplary embodiments. The periodic UL WUS resource 266 includes is configured with a periodicity and a slot offset. The gNB is in a sleep state 262a and, during the sleep state 2628, three periodic UL WUS resources are provided, e.g., UL WUS resources 266a, 266b, and 266c.

In this example, during the gNB sleep state 262a, the UL WUS is not transmitted in the first UL WUS resource 266a or the second UL WUS resource 266b. Thus, the gNB maintains the sleep state and the UE does not expect to be scheduled.

The UE transmits a UL WUS 268 during the third UL WUS resource 266c. The gNB receiving the UL WUS 268 can determine based on gNB implementation whether to wake up. If the gNB decides to wake up, the UE can receive a confirmation from the gNB that the gNB will wake up, e.g., a wake indication 270. The gNB wakes up for some duration 264 that can allow the UE to transmit data/signals on the UL. Prior to resuming the sleep state 262b, the gNB provides and the UE receives an indication that the gNB will sleep, e.g., sleep indication 272. The gNB sleeps in duration 262b and the UE receiving the sleep indication 272 does not expect to be scheduled for UL transmissions/signals.

In the exemplary embodiments described above, the UL WUS resource(s) can be a part of PRACH resource(s) or a separate resource(s). Each UL WUS resource may also be configured in association with SSB or RACH resource.

In some embodiments, a prohibit timer and/or a maximum transmission number can be configured per UL WUS resource. Regarding the prohibit timer, the UE can start the timer upon transmitting a UL WUS and refrain from transmitting another UL WUS until the expiry of the timer. Regarding the maximum transmission number, the UE can transmit up to this number of UL WUS and refrain from transmitting another UL WUS until some pre-defined (e.g., configured) duration elapses.

In some embodiments, the UE can be configured with a trigger condition for transmitting the UL WUS. For example, the trigger condition can comprise the arrival of UL data or signaling to trigger RACH. The trigger condition can be configured for the VE in SIB.

When the condition triggers, the UE can indicate in the UL WUS whether the UE has UL data arrival (for INACTIVE UEs) or UL signaling to trigger RACH (for IDLE/INACTIVE UEs). For example, 1 bit in the UL WUS can be used. In another example, multiple bits can be used to indicate, e.g., different types of UL signaling, e.g., a registration update or a service request. Thus, the gNB can be notified of the reason for the UL WUS. In another embodiment, no separate indication is used and the UL WUS indicates either (or both) the UL data arrival or the UL signaling to trigger RACH. Thus, the gNB is notified only that the UE prefers the gNB to wake up for reception.

According to another aspect of these exemplary embodiments, the UE behavior is described for transmitting the UL WUS after triggering. In one embodiment, some preambles of PRACH are reserved for UL WUS purposes. In this embodiment, the UL WUS signal transmission procedure can comprise the preamble transmission procedure using one of the preambles reserved for UL WUS. The gNB receiving the preamble interprets the preamble reception as the UL WUS.

In another embodiment, new sequences are introduced for UL WUS purposes. When one or more new sequences are introduced for UL WUS purposes, the UL WUS transmission procedure can comprise the following steps, The UE picks a sequence for UL WUS and selects a UL WUS resource to send the UL WUS if multiple UL WUS resources are reserved. To select a UL WUS resource from among multiple available UL WUS resources, the following options can be used. In one option, the UE can measure the radio quality of the respective UL WUS resources. One SSB can be configured to be associated with one respective UL WUS resource, similar to RACH. The UE can, based on its implementation, select one UL WUS resource among the available resource(s) whose associated SSB radio quality is greater than a threshold. In another option, one RACH resource is configured to be associated with one UL WUS resource. The VE can select one UL WUS resource if its associated RACH resource is selected to send the latest preamble.

After selecting the sequence and UL WUS resource, the UE next determines the transmit power for this UL WUS transmission. In one option, the same mechanism can be used as that for determining the transmit power of the RACH preamble. This process generally comprises a retransmission procedure wherein the UE first transmits at a low power and incrementally increased the transmit power in successive retransmissions until a maximum power or a maximum number of retransmissions is reached. Separate parameters for the UL WUS transmission/retransmission procedure can be defined including, e.g. RECEIVED_TARGET_POWER, POWER_RAMPING_COUNTER and PREAMBLE_POWER_RAMPING_STEP. In another option, the transmit power can be that same as the transmit power used for the latest preamble transmission. After determining these WUS transmission parameters, the UE transmits the UL WUS.

In either of the embodiments described above, after completion of the UL WUS signal transmission, the UE can start a prohibit timer. During the duration of the prohibit timer, the UE monitors for UE group common (GC) signaling that indicates whether the gNB wakes up or enters a different gNB sleep mode. The UE can monitor for some duration or in some DL resource(s) configured in SIB or fixed in spec. The UE GC signaling indicating the upcoming wake up or sleep state of the gNB can be DCI or MAC-CE.

If the monitoring window expires and the UE group common signaling is not detected, the UE can trigger the UL WUS retransmission after the prohibit timer expires. If the retransmission number is to exceed the configured threshold, the following options can be used. In one option, the UE can trigger a cell reselection procedure with the current cell as lowest priority. In another option, the UE can bar this cell for a duration, e.g., up to 300 s. In still another option, the UE can abort the attempt to send the UL WUS signal.

If the UE group common signaling is detected, the UE stops the prohibit timer, and applies the UE group common signaling.

In another aspect of these exemplary embodiments, the contents of the UL WUS are described. Depending on the sequence design of the UL WUS signal, the UL WUS signal may carry certain types of information in an explicit manner.

When cell DRX/DTX is configured, and the UL WUS is in the ON duration, the UL WUS can carry an explicit indication of: which RACH resource the UE intends to trigger RACH for UL traffic in the upcoming cell DRX/DTX OFF duration; which RACH resource the UE intends to trigger RACH for UL signaling in upcoming cell DRX/DTX OFF duration; or which RACH resource the UE intends to trigger RACH in upcoming Cell DRX/DTX OFF duration

When cell DRX/DTX is configured, and the UL WUS is in the OFF duration, the UL WUS can carry an explicit indication of: which RACH resource the UE intends to trigger RACH for UL traffic in the upcoming cell DRX/DTX ON duration; which RACH resource the UE intends to trigger RACH for UL signaling in the upcoming cell DRX/DTX ON duration; or which RACH resource the UE intends to trigger RACH in the upcoming cell DRX/DTX ON duration

When cell DRX/DTX is not configured, the UL WUS can carry an explicit indication of: whether the UE intends to trigger RACH for UL data in the upcoming RACH resource resource(s); or whether the UE intends to trigger RACH for UL signaling in the coming RACH resource resource(s)

Alternatively, in some scenarios, the UE can indicate the above information implicitly. For example, the UE could be configured with multiple UL WUS configurations corresponding to different resources, and the UE may select the UL WUS resource to indicate the above information implicitly.

In another aspect of these exemplary embodiments, upon reception of the UL WUS signal, the gNB detects the UL WUS signal without needing to differentiate which UE transmitted the UL WUS signal. The gNB determines whether to wake up, as described above. For example, depending on the number of UEs with pending UL transmissions, the gNB can decide to wake up during the upcoming duration or postpone the wakeup for a future duration. If the gNB decides to wake up or change a sleep state, the gNB can send UE group common signaling on its wake-up or sleep mode change.

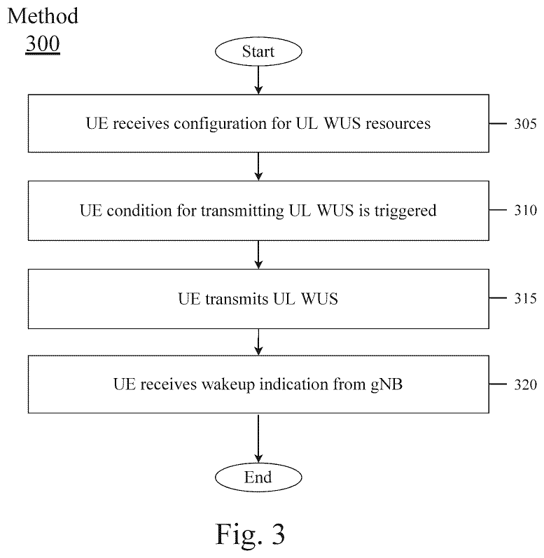

FIG. 3 shows an exemplary method 300 for configuring a UL wakeup signal (WUS) resource and transmitting a UL WUS according to various exemplary embodiments. In some embodiments, the cell configuring the UL WUS resource can implement a cell DRX/DTX cycle. As described above, the cell DRX/DTX cycle can include an ON duration during which the gNB can be in a wakeup state and an OFF duration during which the gNB can be in a sleep state of reduced operations or inactivity. In other embodiments, the cell does not implement a cell DRX/DTX cycle but can otherwise enter into a sleep state of reduced operations or inactivity. In this example, the UE is in the RRC IDLE or INACTIVE state.

In 305, the UE receives a configuration for UL WUS resources. The UL WUS resources can be periodic or aperiodic and can be signaled in SIB for the IDLE/INACTIVE UE. In some embodiments, the SIB can also indicate a cell DRX/DTX configuration. If cell DRX/DTX is configured, the UL WUS resources can be configured with a starting slot relative to a starting time of the cell DRX/DTX ON duration or OFF duration. If the UL WUS resources are aperiodic, the resource can be triggered during the cell DRX/DTX ON duration via group common (GC) signaling. The configuration can indicate the slot offset and the periodicity. The UL WUS resource(s) can be part of PRACH resource(s) or separate resource(s) and can be associated with SSB or RACH resources. A prohibit time and/or a maximum transmission number can also be configured for the UL WUS transmission.

The UE can also receive a configuration for a trigger condition for transmitting the UL WUS. The trigger condition can be configured in SIB. For example, the trigger condition can comprise UL data arrival, RACH being triggered, or either UL data arrival or RACH being triggered.

In 310, the condition for transmitting the UL WUS is triggered. As described above, the UE can have UL data arrival or RACH may be triggered. If one or more UL WUS resources are available in an upcoming duration, the VE can initiate a UL WUS transmission procedure. If, for example, the configured UL WUS resource is aperiodic, the UE can wait until the aperiodic resource is triggered for the UE via GC signaling.

In 315, the UE transmits the UL WUS in an available UL WUS resource. To transmit the UL WUS, the UE can use a PRACH preamble reserved for UL WUS purposes or can use a new sequence introduced for UL WUS purposes. If the PRACH preamble is used, the UE can follow the same preamble transmission procedure as that used for RACH. If the new sequence is used, the UE can select a UL WUS resource for sending the UL WUS, if multiple resources are available. The UL WUS resource can be selected based on an SSB radio quality for an SSB associated with the respective resources. Alternatively, if the UL WUS resources are associated with a RACH resource, the UL WUS resource can be selected which is associated with the RACH resource selected to send the latest preamble. For transmitting the new sequence, the transmit power can be determined according to a mechanism similar to that for determining the transmit power of the PRACH preamble, e.g., increasing the transmit power incrementally for a number of retransmissions. Alternatively, the same transmit power can be used as that which was used for the latest preamble transmission.

The UL WUS can include an explicit indication of which RACH resource the UE intends to trigger for RACH in an upcoming duration, or this may be indicated implicitly by selecting one from multiple UL WUS configurations corresponding to different resources.

If the UE is configured with a prohibit timer, the UE can start the timer upon transmission of the UL WUS. a wake indication is not received from the gNB within a monitoring window, the UE can retransmit the UL WUS after the prohibit timer expires. If the UE is configured with a maximum number of retransmissions, and the response from the gNB is not received after the max number of retransmissions is sent, the UE can trigger cell reselection, bar the cell for a duration, or abort the attempt to send the UL WUS.

The gNB receiving the WUS can determine whether to change its upcoming sleep state or wake state based on gNB implementation. As described above, the gNB can make this determination based on a number of different factors. In the example of method 300, the gNB determines to wake up. The gNB transmits the response to the UE and the method proceeds to 320.

In 320, the UE receives a wakeup indication from the gNB, e.g., a confirmation from the gNB that the UE request was honored. The wakeup indication can comprise, e.g., GC signaling, indicating a change of the gNB sleep mode in an upcoming duration. The UE can apply the signaling and end the prohibit timer.

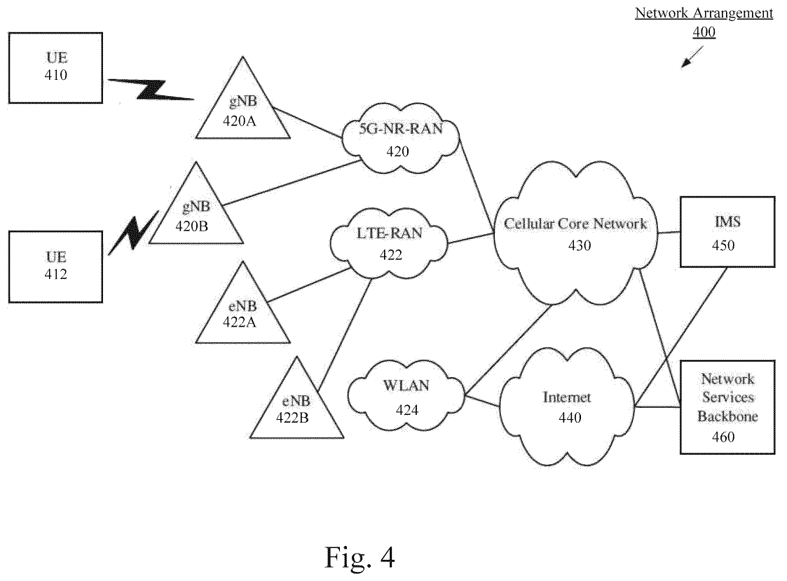

FIG. 4 shows an exemplary network arrangement 400 according to various exemplary embodiments. The exemplary network arrangement 400 includes UEs 410, 412. Those skilled in the art will understand that the UEs 410, 412 may be any type of electronic component that is configured to communicate via a network, e.g., mobile phones, tablet computers, desktop computers, smartphones, phablets, embedded devices, wearables (e.g., HMD, AR glasses, etc.), Internet of Things (IOT) devices, etc. It should also be understood that an actual network arrangement may include any number of UEs being used by any number of users. Thus, the example of two UEs 410, 412 is merely provided for illustrative purposes.

The UEs 410, 412 may communicate directly with one or more networks. In the example of the network configuration 400, the networks with which the UEs 410, 412 may wirelessly communicate are a 5G NR radio access network (5G NR-RAN) 420, an LTE radio access network (LTE-RAN) 422 and a wireless local access network (WLAN) 424. However, the UEs 410, 412 may also communicate with other types of networks and the UEs 410, 412 may also communicate with networks over a wired connection.

Therefore, the UEs 410, 412 may include a 5G NR chipset to communicate VE 410 with the 5G NR-RAN 420, an LTE chipset to communicate with the LIE-RAN 422 and an ISM chipset to communicate with the WLAN 424.

The 5G NR-RAN 420 and the LTE-RAN 422 may be portions of cellular networks that may be deployed by a network carrier (e.g., Verizon, AT&T, T-Mobile, etc.) . These networks 420, 422 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 424 may include any type of wireless local area network (WiFi, Hot Spot, IEEE 802.11x networks, etc.).

The UEs 410, 412 may connect to the 5G NR-RAN via the gNB 420A or the gNB 420B. Reference to two gNBs 420A, 420B is merely for illustrative purposes. The exemplary embodiments may apply to any appropriate number of gNBs. The UEs 410, 412 may also connect to the LTE-RAN 422 via the eNBs 422A, 422B. Those skilled in the art will understand that any association procedure may be performed for the UEs 410, 412 to connect to the 5G NR-RAN 420 and the LTE-RAN 422. For example, as discussed above, the 5G NR-RAN 420 and the LTE-RAN 422 may be associated with a particular cellular provider where the UEs 410, 412 and/or the user thereof has a contract and credential information (e.g., stored on a SIM card). Upon detecting the presence of the 5G NR-RAN 420, the UEs 410, 412 may transmit the corresponding credential information to associate with the 5G NR-RAN 420. More specifically, the UEs 410, 412 may associate with a specific base station (e.g., the gNB 420A of the 5G NR-RAN 420, the eNB 422A of the LTE-RAN 422).

In addition to the networks 420, 422 and 424 the network arrangement 400 also includes a cellular core network 430, the Internet 440, an IP Multimedia Subsystem (IMS) 450, and a network services backbone 460. The cellular core network 430 may be considered to be the interconnected set of components that manages the operation and traffic of the cellular network. The cellular core network 430 also manages the traffic that flows between the cellular network and the Internet 440. The IMS 450 may be generally described as an architecture for delivering multimedia services to the UE 410 using the IP protocol. The IMS 450 may communicate with the cellular core network 430 and the Internet 440 to provide the multimedia services to the UE 410. The network services backbone 460 is in communication either directly or indirectly with the Internet 440 and the cellular core network 430. The network services backbone 460 may be generally described as a set of components (e.g., servers, network storage arrangements, etc.) that implement a suite of services that may be used to extend the functionalities of the UEs 410, 412 in communication with the various networks.

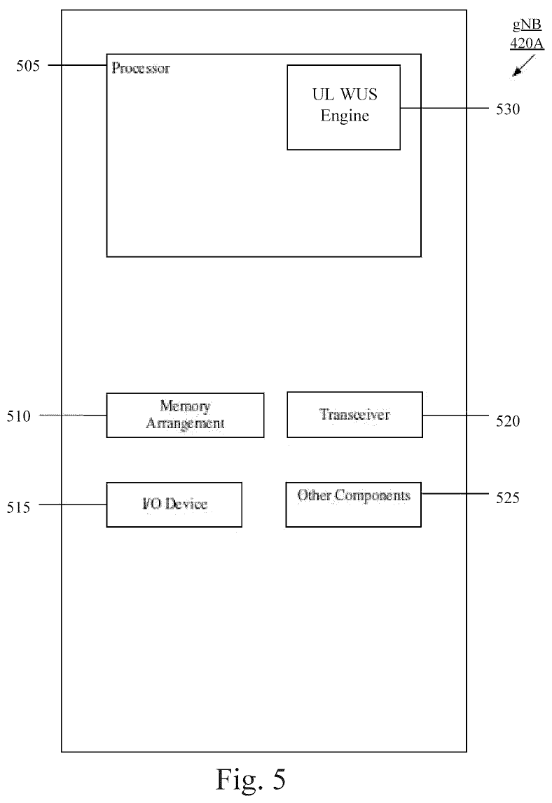

FIG. 5 shows an exemplary base station 420A according to various exemplary embodiments. The base station 420A will be described with regard to the network arrangement 400 of FIG. 4. The base station 420A may represent any access node through which the UE 410 may establish a connection and manage network operations. The base station 420A may also represent the gNB 420B described above with respect to FIG. 4.

The base station 420A may include a processor 505, a memory arrangement 510, an input/output (I/O) device 515, a transceiver 520, and other components 525. The other components 525 may include, for example, a battery, a data acquisition device, ports to electrically connect the base station 420A to other electronic devices, etc.

The processor 505 may be configured to execute a plurality of engines of the base station 420A. For example, the engines may include a UL WUS engine 530 for performing operations related to configuring the UL WUS resources for the UE, configuring trigger conditions and/or other constraints for the UL WUS, receiving the UL WUS and transmitting an indication to the UE of a change of sleep/wake state, as described above.

The above noted engine 530 being an application (e.g., a program) executed by the processor 505 is only exemplary. The functionality associated with the engine 530 may also be represented as a separate incorporated component of the base station 420A or may be a modular component coupled to the base station 420A, e.g., an integrated circuit with or without firmware. For example, the integrated circuit may include input. circuitry to receive signals and processing circuitry to process the signals and other information. In addition, in some base stations, the functionality described for the processor 505 is split among a plurality of processors (e.g., a baseband processor, an applications processor, etc.) . The exemplary embodiments may be implemented in any of these or other configurations of a base station.

The memory 510 may be a hardware component configured to store data related to operations performed by the base station 420A. The I/O device 515 may be a hardware component or ports that enable a user to interact with the base station 420A. The transceiver 520 may be a hardware component configured to exchange data with the UE 410 and any other UE in the system 400. The transceiver 520 may operate on a variety of different frequencies or channels (e.g., set of consecutive frequencies). Therefore, the transceiver 520 may include one or more components (e.g., radios) to enable the data exchange with the various networks and UEs.

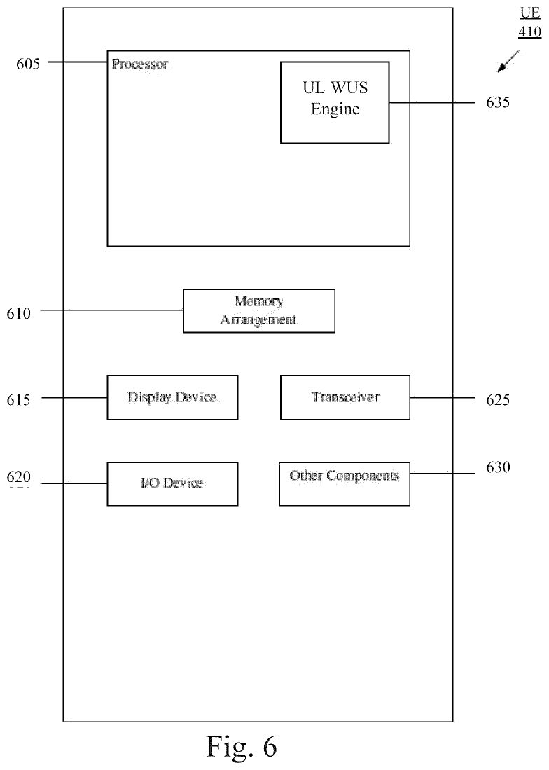

FIG. 6 shows an exemplary UE 410 according to various exemplary embodiments. The UE 410 will be described with regard to the network arrangement 400 of FIG. 4. The UE 410 may also represent VE 412. The UE 410 may include a processor 605, a memory arrangement 610, a display device 615, an input/output (I/O) device 620, a transceiver 625 and other components 630.

The other components 630 may include, for example, an audio input device, an audio output device, a power supply, a data acquisition device, ports to electrically connect the VE 410 to other electronic devices, etc.

The processor 605 may be configured to execute a plurality of engines of the UE 410. For example, the engines may include a UL WUS engine 635 for performing operations related to receiving a configuration for UL WUS resources from a serving cell, determining trigger conditions are met and/or other constraints should be imposed for the UL WUS, transmitting the UL WUS and receiving an indication from the cell of a change of sleep/wake state, as described above.

The above referenced engine 635 being an application (e.g., a program) executed by the processor 605 is provided merely for illustrative purposes. The functionality associated with the engine 635 may also be represented as a separate incorporated component of the UE 410 or may be a modular component coupled to the UE 410, e.g., an integrated circuit with or without firmware. For example, the integrated circuit may include input circuitry to receive signals and processing circuitry to process the signals and other information. The engines may also be embodied as one application or separate applications. In addition, in some UES, the functionality described for the processor 605 is split among two or more processors such as a baseband processor and an applications processor. The exemplary embodiments may be implemented in any of these or other configurations of a UE.

The memory arrangement 610 may be a hardware component configured to store data related to operations performed by the UE 410. The display device 615 may be a hardware component configured to show data to a user while the I/O device 620 may be a hardware component that enables the user to enter inputs. The display device 615 and the I/O device 620 may be separate components or integrated together such as a touchscreen. The transceiver 625 may be a hardware component configured to establish a connection with the 5G NR-RAN 420 and/or any other appropriate type of network. Accordingly, the transceiver 625 may operate on a variety of different frequencies or channels (e.g., set of consecutive frequencies).

### Examples

In a first example, a method performed by a user equipment (UE), comprising receiving a configuration from a network cell for an uplink (UL) wakeup signal (WUS) resource, determining to transmit a UL WUS when a condition is triggered, the condition comprising either one of UL data arrival or a triggering of a random access (RACH) procedure when the network cell is in a sleep state or is anticipated to enter the sleep state in an upcoming duration, selecting a sequence for transmitting the UL WUS, the sequence comprising a physical RACH (PRACH) preamble reserved for UL WUS or a sequence introduced for UL WUS, transmitting the UL WUS and monitoring for signaling indicating whether the network cell wakes up or enters a different sleep state.

In a second example, the method of the first example, wherein the configuration for the UL WUS resource is received in a system information block (SIB).

In a third example, the method of the second example, wherein a cell discontinuous reception or discontinuous transmission (DRX/DTX) cycle is configured and a starting slot of the UL WUS resource is configured relative to a starting time of an ON duration or an OFF duration of the cell DRX/DTX cycle.

In a fourth example, the method of the third example, wherein the SIB includes a parameter x, wherein the starting slot of the UL WUS resource is x slots before the starting time of the ON duration or the OFF duration.

In a fifth example, the method of the fourth example, wherein the configuration for the UL WUS resource further includes a periodicity.

In a sixth example, the method of the third example, wherein the UL WUS resource is aperiodic and is located in the ON duration of the cell DRX/DTX cycle, wherein the UL WUS resource is triggered via group common signaling in the ON duration.

In a seventh example, the method of the sixth example, wherein the GC signaling is a downlink control information (DCI) comprising a paging short message or a paging early indication (PEI) DCI 2_7.

In an eighth example, the method of the second example, wherein a cell discontinuous reception or discontinuous transmission (DRX/DTX) cycle is not configured and the configuration for the UL WUS resource includes a periodicity and a slot offset,

In a ninth example, the method of the first example, wherein the UL WUS resources are configured as a part of PRACH resources.

In a tenth example, the method of the ninth example, wherein the PRACH preamble reserved for the UL WUS is transmitted on the UL WUS resource that is a part of PRACH resources and the UL WUS transmission comprises a preamble transmission procedure,

In an eleventh example, the method of the first example, wherein the UL WUS resource is configured separately from PRACH resources and the new sequence introduced for UL WUS is transmitted on the UL WUS resource.

In a twelfth example, the method of the eleventh example, wherein multiple UL WUS resources are available for UL WUS transmission, wherein the method further comprise selecting one of the multiple UL WUS resources for transmitting the UL WUS.

In a thirteenth example, the method of the twelfth example, wherein a respective synchronization signal block (SSB) is configured to be associated with a respective UL WUS resource, wherein the one of the multiple UL WUS resources for transmitting the UL WUS is selected based on an associated SSB radio quality.

In a fourteenth example, the method of the twelfth example, wherein a respective RACH resource is configured to be associated with a respective UL WUS resource, wherein the one of the multiple UL WUS resources for transmitting the UL WUS is selected based on an associated RACH resource being selected to transmit a latest preamble.

In a fifteenth example, the method of the eleventh example, further comprising determining a transmit power for transmitting the UL WUS.

In a sixteenth example, the method of the fifteenth example, wherein the transmit power is determined according to a same mechanism as that which is used to determine a transmit power for transmitting the PRACH preamble, wherein separate parameters for received target power, power ramping counter, and preamble power ramping step are used for transmitting the UL WUS.

In a seventeenth example, the method of the fifteenth example, wherein the transmit power is determined as a same transmit power as that which was used for a latest preamble transmission.

In an eighteenth example, the method of the first example, wherein the UL WUS includes an indication that the UE has UL data arrival, an indication that the UE has UL signaling to trigger RACH, or an indication that the UE has either the UL data arrival or the UL signaling.

In a nineteenth example, the method of the eighteenth example, wherein the indication that the UE has UL signaling to trigger RACH comprises multiple bits to indicate different types of the UL signaling.

In a twentieth example, the method of the eighteenth example, wherein the UL WUS further indicates which RACH resource the UE intends to trigger for RACH for the UL traffic or the UL signaling.

In a twenty first example, the method of the twentieth example, wherein the indication of which RACH resource the UE intends to trigger for RACH is indicated explicitly or implicitly based on which UL WUS resource is selected by the UE.

In a twenty second example, the method of the first example, further comprising receiving a configuration for a prohibit timer associated with the UL WUS resources and upon transmission of the UL WUS, starting the prohibit timer, wherein the UE does not attempt a retransmission of the UL WUS until the expiry of the prohibit timer.

In a twenty third example, the method of the twenty second example, wherein the UE monitors for the signaling indicating whether the network cell wakes up or enters the different sleep state during a monitoring window comprising a duration or some downlink (DL) resources configured in a system information block (SIB) or fixed in specification.

In a twenty fourth example, the method of the twenty third example, wherein, when the monitoring window expires prior to receiving the signaling indicating whether the network cell wakes up or enters a different sleep state, the method further comprising retransmitting the UL WUS after the prohibit timer expires.

In a twenty fifth example, the method of the twenty fourth example, further comprising receiving a configuration for a maximum number of retransmissions and attempting the retransmission of the UL WUS up to the maximum number of retransmissions.

In a twenty sixth example, the method of the twenty fifth example, wherein, when the maximum number of retransmissions is reached, the method further comprising triggering a cell reselection procedure with the network cell as a lowest priority or barring the network cell for a duration or aborting the UL WUS transmission.

In a twenty seventh example, the method of the twenty third example, further comprising detecting the signaling indicating whether the network cell wakes up or enters the different sleep state and applying the signaling and stopping the prohibit timer.

In a twenty eighth example, the method of the twenty seventh example, wherein the signaling comprises group common (GC) signaling.

In a twenty ninth example, a processor configured to perform any of the methods of the first through twenty eighth examples.

In a thirtieth example, a user equipment comprising a transceiver configured to communicate with a network and a processor configured to perform any of the methods of the first through twenty eighth examples and communicatively coupled to the transceiver.

In a thirty first example, a non-transitory computer readable storage medium comprising a set of instructions that when executed perform any of the methods of the first through twenty eighth examples.

In a thirty second example, a method performed by a base station, comprising transmitting a configuration to a user equipment (UE) for an uplink (UL) wakeup signal (WUS) resource, receiving a UL WUS from the UE, the UL WUS being transmitted using a sequence comprising a physical RACH (PRACH) preamble reserved for UL WUS or a sequence introduced for UL WUS, the UL WUS indicating either one of UL data arrival or a triggering of a random access (RACH) procedure for the UE and determining whether to wake up or enter a different sleep state in an upcoming duration based in part on the received UL WUS.

In a thirty third example, the method of the thirty second example, wherein the configuration for the UL WUS resource is transmitted in a system information block (SIB).

In a thirty fourth example, the method of the thirty third example, wherein a cell discontinuous reception or discontinuous transmission (DRX/DTX) cycle is configured and a starting slot of the UL WUS resource is configured relative to a starting time of an ON duration or an OFF duration of the cell DRX/DTX cycle.

In a thirty fifth example, the method of the thirty fourth example, wherein the SIB includes a parameter x, wherein the starting slot of the UL WUS resource is x slots before the starting time of the ON duration or the OFF duration.

In a thirty sixth example, the method of the thirty fifth example, wherein the configuration for the UL WUS resource further includes a periodicity.

In a thirty seventh example, the method of the thirty fourth example, wherein the UL WUS resource is aperiodic and is located in the ON duration of the cell DRX/DTX cycle, wherein the UL WUS resource is triggered via group common signaling in the ON duration.

In a thirty eighth example, the method of the thirty seventh example, wherein the GC signaling is a downlink control information (DCI) comprising a paging short message or a paging early indication (PEI) DCI 2_7.

In a thirty ninth example, the method of the thirty third example, wherein a cell discontinuous reception or discontinuous transmission (DRX/DTX) cycle is not configured and the configuration for the UL WUS resource includes a periodicity and a slot offset.

In a fortieth example, the method of the thirty second example, wherein the UL WUS resources are configured as a part of PRACH resources.

In a forty first example, the method of the fortieth example, wherein the PRACH preamble reserved for the UL WUS is received on the UL WUS resource that is a part of PRACH resources.

In a forty second example, the method of the thirty second example, wherein the UL WUS resource is configured separately from PRACH resources and the new sequence introduced for UL WUS is received on the UL WUS resource.

In a forty third example, the method of the forty second example, wherein multiple UL WUS resources are available for UL WUS reception and the UE selects one of the multiple UL WUS resources for transmitting the UL WUS.

In a forty fourth example, the method of the forty third example, wherein a respective synchronization signal block (SSB) is configured to be associated with a respective UL WUS resource, wherein the one of the multiple UL WUS resources for transmitting the UL WUS is selected based on an associated SSB radio quality.

In a forty fifth example, the method of the forty third example, wherein a respective RACH resource is configured to be associated with a respective UL WUS resource, wherein the one of the multiple UL WUS resources for transmitting the UL WUS is selected based on an associated RACH resource being selected to transmit a latest preamble.

In a forty sixth example, the method of the thirty second example, wherein the UL WUS includes an indication that the UE has UL data arrival, an indication that the UE has UL signaling to trigger RACH, or an indication that the UE has either the UL data arrival or the UL signaling.

In a forty seventh example, the method of the forty sixth example, wherein the indication that the UE has UL signaling to trigger RACH comprises multiple bits to indicate different types of the UL signaling.

In a forty eighth example, the method of the forty seventh example, wherein the UL WUS further indicates which RACH resource the UE intends to trigger for RACH for the UL traffic or the UL signaling.

In a forty ninth example, the method of the forty eighth example, wherein the indication of which RACH resource the UE intends to trigger for RACH is indicated explicitly or implicitly based on which UL WUS resource is selected by the UE.

In a fiftieth example, the method of the thirty second example, further comprising transmitting a configuration for a prohibit timer associated with the UL WUS resources, transmitting a configuration for a monitoring window comprising a duration or some downlink (DL) resources and transmitting a configuration for a maximum number of retransmissions.

In a fifty first example, the method of the thirty second example, further comprising transmitting signaling indicating whether the base station wakes up or enters the different sleep state.

In a fifty second example, the method of the fifty first example, wherein the signaling comprises group common (GC) signaling.

In a fifty third example, a processor configured to perform any of the methods of the thirty second through fifty second examples.

In a fifty fourth example, a base station comprising a transceiver configured to communicate with a user equipment (UE) and a processor configured to perform any of the methods of the thirty second through fifty second examples and communicatively coupled to the transceiver.

In a fifty fifth example, a non-transitory computer readable storage medium comprising a set of instructions that when executed perform any of the methods of the thirty second through fifty second examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A method performed by a user equipment (UE), comprising:
receiving a configuration from a network cell for an uplink (UL) wakeup signal (WUS) resource;
determining to transmit a UL WUS when a condition is triggered, the condition comprising either one of UL data arrival or a triggering of a random access (RACH) procedure when the network cell is in a sleep state or is anticipated to enter the sleep state in an upcoming duration;
selecting a sequence for transmitting the UL WUS, the sequence comprising a physical RACH (PRACH) preamble reserved for UL WUS or a sequence introduced for UL WUS;
transmitting the UL WUS; and
monitoring for signaling indicating whether the network cell wakes up or enters a different sleep state.

2. The method of claim 1, wherein the configuration for the UL WUS resource is received in a system information block (SIB).

3. The method of claim 2, wherein a cell discontinuous reception or discontinuous transmission (DRX/DTX) cycle is configured and a starting slot of the UL WUS resource is configured relative to a starting time of an ON duration or an OFF duration of the cell DRX/DTX cycle.

4. The method of claim 2, wherein a cell discontinuous reception or discontinuous transmission (DRX/DTX) cycle is not configured and the configuration for the UL WUS resource includes a periodicity and a slot offset.

5. The method of claim 1, wherein the UL WUS resources are configured as a part of PRACH resources.

6. The method of claim 1, wherein the UL WUS resource is configured separately from PRACH resources and the sequence introduced for UL WUS is transmitted on the UL WUS resource.

7. The method of claim 6, wherein multiple UL WUS resources are available for UL WUS transmission, the method further comprising:
selecting one of the multiple UL WUS resources for transmitting the UL WUS.

8. The method of claim 6, further comprising:
determining a transmit power for transmitting the UL WUS.

9. The method of claim 1, wherein the UL WUS includes an indication that the UE has UL data arrival, an indication that the UE has UL signaling to trigger RACH, or an indication that
the UE has either the UL data arrival or the UL signaling.

10. The method of claim 1, further comprising:
receiving a configuration for a prohibit timer associated with the UL WUS resources; and upon transmission of the UL WUS, starting the prohibit timer, wherein the UE does not attempt a retransmission of the UL WUS until the expiry expiration of the prohibit timer.

11. A method performed by a base station, comprising:
transmitting a configuration to a user equipment (UE) for an uplink (UL) wakeup signal (WUS) resource;
receiving a UL WUS from the UE, the UL WUS being transmitted using a sequence comprising a physical RACH (PRACH) preamble reserved for UL WUS or a sequence introduced for UL WUS, the UL WUS indicating either one of UL data arrival or a triggering of a random access (RACH) procedure for the UE; and
determining whether to wake up or enter a different sleep state in an upcoming duration based in part on the received UL WUS.

12. The method of claim 11, wherein the configuration for the UL WUS resource is transmitted in a system information block (SIB).

13. The method of claim 12, wherein a cell discontinuous reception or discontinuous transmission (DRX/DTX) cycle is configured and a starting slot of the UL WUS resource is configured relative to a starting time of an ON duration or an OFF duration of the cell DRX/DTX cycle.

14. The method of claim 12, wherein a cell discontinuous reception or discontinuous transmission (DRX/DTX) cycle is not configured and the configuration for the UL WUS resource includes a periodicity and a slot offset.

15. The method of claim 11, wherein the UL WUS resources are configured as a part of PRACH resources.

16. The method of claim 11, wherein the UL WUS resource is configured separately from PRACH resources and the sequence introduced for UL WUS is received on the UL WUS resource.

17. The method of claim 16, wherein multiple UL WUS resources are available for UL WUS reception and the UE selects one of the multiple UL WUS resources for transmitting the UL WUS.

18. The method of claim 11, wherein the UL WUS includes an indication that the UE has UL data arrival, an indication that the UE has UL signaling to trigger RACH, or an indication that the UE has either the UL data arrival or the UL signaling.

19. The method of claim 11, further comprising:
transmitting a configuration for a prohibit timer associated with the UL WUS resources;
transmitting a configuration for a monitoring window comprising a duration or some downlink (DL) resources; and
transmitting a configuration for a maximum number of retransmissions.

20. The method of claim 11, further comprising:
transmitting signaling indicating whether the base station wakes up or enters the different sleep state.
